(19) United States
(12) Patent Application Publication
(10) Pub. No.: US 2017/0127650 A1
(43) Pub. Date: May 11, 2017

(54) Water Bowl

(71) Applicant: Leslie Joline, Conowingo, MD (US)

(72) Inventor: Leslie Joline, Conowingo, MD (US)

(21) Appl. No.: 15/163,085

(22) Filed: May 24, 2016

Related U.S. Application Data
(60) Provisional application No. 62/251,143, filed on Nov. 5, 2015.

(51) Int. Cl. A01K 7/06; A01K 7/02; A01K 7/04

(52) U.S. Cl. CPC A01K 7/06; A01K 7/04; A01K 7/022

(57) ABSTRACT

A water bowl for a pet that automatically refills itself. The water bowl includes a bowl having an open interior volume in which water can be stored. A water supply tube extends from an exterior of the bowl to an interior thereof. The water supply tube includes a connector thereon that is configured to removably receive a water supply line. The water supply tube includes a float valve, having a float that is disposed within the bowl. When the water level in the bowl drops below a certain level the change in position of the float causes the float valve to open so that water from the water supply line flows through the water supply tube and into the bowl.

### CROSS REFERENCE TO RELATED APPLICATION

This application claims the benefit of U.S. Provisional Application No. 62/251,143 filed on Nov. 5, 2015. The above identified patent application is herein incorporated by reference in its entirety to provide continuity of disclosure.

### BACKGROUND OF THE INVENTION

### Field of the Invention

The present invention relates to water bowls. More specifically, the present invention provides a water bowl for a pet that automatically refills with water when the water level within the bowl has dropped below a predetermined level.

It is important to provide pets with fresh water each day so that the pet can stay properly hydrated and maintain its health. However, pet owners can be forgetful and may fail to fill the pet's water bowl when it is empty. The pet owner may simply not notice when the water bowl is empty and it may take some time for the pet owner to realize that his or her pet needs new water. As a result, the pet may be left without water for some time.

Further, elderly pet owners and people having disabilities may have difficulty constantly picking up a water bowl, filling the bowl with water, and then placing it back down onto the ground. The pet owner may have trouble bending over to pick up the bowl and may tire from doing so several times each day. As a result, the pet owner may fail to fill the pet's bowl with water when it is needed. Thus, a water bowl that automatically refills with water when empty is desired.

Devices have been disclosed in the prior art that relate to pet water bowls. These include devices that have been patented and published in patent application publications. These devices generally relate to automatic water bowls and liquid dispensers for pets, such as U.S. Pat. No. 5,813,363, U.S. Pat. No. 6,253,709, U.S. Pat. No. 7,438,020, U.S. Pat. No. 8,800,494, and U.S. Pat. No. 5,730,082.

These prior art devices have several known drawbacks. While the prior art devices provide automatic means for dispensing water, these devices do not provide a standalone water bowl that can be connected to a water line and that automatically refills the water in the bowl when the water level drops below a predetermined level.

In light of the devices disclosed in the prior art, it is submitted that the present invention substantially diverges in design elements from the prior art and consequently it is clear that there is a need in the art for an improvement to existing water bowl devices. In this regard the instant invention substantially fulfills these needs.

### SUMMARY OF THE INVENTION

In view of the foregoing disadvantages inherent in the known types of water bowls now present in the prior art, the present invention provides a new water bowl wherein the same can be utilized for providing convenience for the user when providing a pet with water.

The present invention provides a water bowl for a pet that automatically refills with water. The water bowl comprises a bowl having an open interior volume adapted to receive and hold water therein. A water supply tube extends through the bowl and includes a connector thereon for receiving a water supply line. The water supply tube further includes a float valve thereon, wherein the float of the float valve is disposed within the water bowl. The float is adapted to remain in position on the surface of the water, and when the water drops below a predetermined level, the float valve opens so as to allow water to flow into the open interior volume through the water supply tube. When the water has filled the bowl, moving the float upwards, the float valve closes.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the water bowl.

FIG. 2 shows a cross sectional view of the water bowl.

FIG. 3 shows a close-up view of the connector of the water bowl.

### DETAILED DESCRIPTION OF THE INVENTION

Reference is made herein to the attached drawings. Like reference numerals are used throughout the drawings to depict like or similar elements of the water bowl. For the purposes of presenting a brief and clear description of the present invention, the preferred embodiment will be discussed as used for providing a pet with water. The figures are intended for representative purposes only and should not be considered to be limiting in any respect.

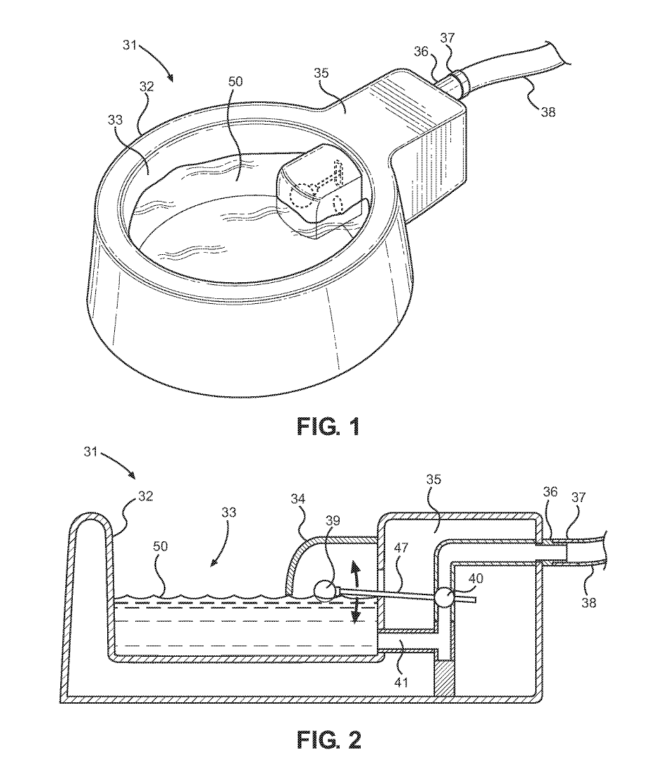

Referring now to FIG. 1, there is shown a perspective view of the water bowl. The water bowl 31 comprises a bowl 32 having an open interior volume 33 in which water 50 can be held and stored. The water bowl 31 is shown as having a substantially circular shape, however, in alternate embodiments the water bowl can have any of various other shapes and configurations. The bowl 32 comprises a base, upstanding sidewalls, and an open upper end. Preferably, the bowl 32 is composed of a durable, corrosion-resistance material, such as a hard plastic, among others.

A rear portion 35 of the bowl 32 includes a connector 36 adapted to receive a mating connector 37 disposed on the end of a water supply line 38. A water supply tube extends through the bowl 32 from the connector 36 to the open interior volume 33 of the bowl 32. In this way, the water supply line 38 is in fluid communication with the water supply tube and with the interior volume 33 of the bowl 32 so that the bowl 32 can be filled with water 50.

Referring now to FIG. 2, there is shown a cross sectional view of the water bowl. A water supply tube 41 extends through the rear portion 35 of the bowl 32. A first end of the water supply tube 41 is open and is positioned on an exterior of the water bowl 32. The first end includes a connector 6 thereon that is adapted to removably engage with a mating connector 37 disposed on the end of a water supply line 38. The supply line 38 can be fitted with the mating connector 37 which prevents water from flowing therethrough when the supply line 38 is not connected to the water bowl 31. When the mating connector 37 is engaged with the connector 36 on the water bowl 31, water from the supply line 38 can flow into the water supply tube 41. The second end of the water supply tube 41 terminates at the interior volume 33 of the bowl 32 such that water from the water supply line 38 can fill the interior volume 33 of the bowl 32.

The water supply tube 41 further comprises a float valve 40 thereon. The float valve 40 comprises a valve that opens and closes based upon the position of a float 39 attached to an elongated rod 47 that is pivotally attached to the valve 40. The float 39 is a buoyant body that remains on the surface of the water within the bowl 32. The float valve 40 remains closed when the water level in the bowl is sufficiently high, such that the bowl 32 is full of water. However, as the water level 50 within the bowl 32 drops, the float 39 lowers in elevation, causing the float valve 40 to open once a predetermined water level 50 has been reached. Water can then flow freely into the interior volume 33 of the bowl 32 until the bowl 32 is full. When the water level rises, the elevation of the float 39 increases, causing the float valve 40 to close. Thus, the water bowl 31 automatically refills itself when the water level is too low.

The float 39 is positioned within the water bowl. In order to prevent the pet from accessing the float and damaging or eating the same, a cover 34 is provided that extends over the float 39. The cover 34 preferably comprises an arcuate shape and extends over the area above the float 39.

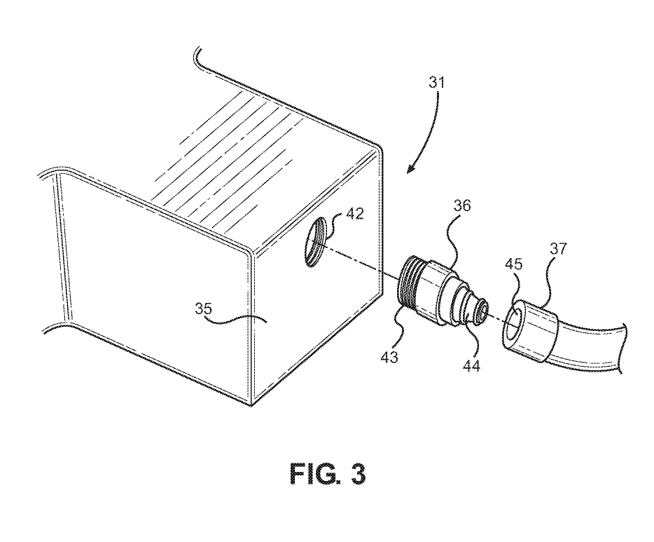

Referring now to FIG. 3, there is shown a close-up view of the connector of the water bowl. The rear portion 35 comprises a connector 36 thereon. In some embodiments, the connector 36 is integrally attached to the rear portion 35 of the water bowl 31 and in other embodiments, the connector 36 is removably secured thereto. In the illustrated embodiment, the connector 36 comprises a threaded portion 43 adapted to removably engage with threading on an opening 42 at the rear portion 35 of the water bowl 31.

The connector 36 further comprises a protrusion 44 thereon that is adapted to engage with a mating cavity 45 on the mating connector 37. The connector 36 includes a hollow bore therethrough so that water supplied by the water supply line can flow therethrough. The mating connector 37 is adapted to prevent water from flowing therethrough unless it is connected to the connector 36. In this way, the pet owner can detach the water supply line from the water bowl 31 without water continually flowing therethrough.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A water bowl for a pet, comprising:
a bowl having an open interior volume configured to be filled with water;
a water supply tube extending through the bowl, wherein the water supply tube includes a first end that terminates within the open interior volume and a second end that terminates at an exterior portion of the bowl;
a connector disposed on the second end of the water supply tube adapted to removably engage with a water supply line that supplies water to the bowl;
a float valve disposed on the water supply tube, wherein the float valve comprises a float disposed within the open interior volume that rests on the surface of the water therein such that the float valve is opened and closed based upon the position of the float.

2) The water bowl of claim 1, wherein a cover extends from the bowl into the open interior volume so as to cover the float positioned within the open interior volume.

3) The water bowl of claim 1, wherein the connector is removably securable to the bowl.

4) The water bowl of claim 1, further comprising a mating connector removably securable to an end of the water supply line, wherein the mating connector removably engages with the connector disposed on the bowl.

5) The water bowl of claim 1, wherein the float valve comprises a valve having an elongated rod extending therefrom wherein the float is disposed on the end of the elongated rod, wherein the valve opens when the float has dropped below a predetermined elevation.

6) The water bowl of claim 4, wherein the connector comprises a protrusion thereon that removably engages with a cavity disposed on the mating connector.
